(19) United States
(12) Patent Application Publication
(10) Pub. No.: US 2026/0246798 A1
(43) Pub. Date: Aug. 20, 2026

(54) MULTI-AGENT SYSTEM FOR SECURITY INCIDENT INVESTIGATION

(71) Applicant: Cisco Technology, Inc., San Jose, CA (US)

(72) Inventors: Yi Hong, Foster City, CA (US); Girish Pulprayil Chandranmenon, Edison, NJ (US); Tian Bu, Basking Ridge, NJ (US); Sunil Navinchandra Amin, Atlanta, GA (US)

(21) Appl. No.: 19/179,603

(22) Filed: Apr. 15, 2025

Related U.S. Application Data
(60) Provisional application No. 63/761,137, filed on Feb. 20, 2025.

(51) Int. Cl. H04L 9/40

(52) U.S. Cl. CPC H04L 63/1425; H04L 63/1441

(57) ABSTRACT

Techniques for investigating security incident(s) using a multi-agent framework to improve efficiency and accuracy of identifying threats, while reducing costs and resource usage of a system. A system may receive alert(s) corresponding to security incident(s) across customer networks. The system may correlate a subset of the alert(s) with a particular security incident and identify resource(s) available to a customer network associated with the security incident. The system may generate, using agent(s), a summary of the security incident and a dynamic playbook to investigate the security incident. The system may execute, using the agent(s), the tasks and generate output(s). The system may generate and display a recommendation for the security incident based on the outputs. The recommendation may include a status of the security incident, recommended action(s), supporting evidence, and more.

### CROSS REFERENCE TO RELATED APPLICATIONS

This application claims priority to U.S. Provisional Patent Application No. 63/761,137, filed Feb. 20, 2025, the entire contents of which are incorporated herein by reference.

### TECHNICAL FIELD

The present disclosure relates generally to provisioning language models on network controllers (and/or other network devices) to improve the ability of the network controllers to manage a network and interact with network operators.

### BACKGROUND

Network security is constantly evolving. With the introduction of generative artificial intelligence and large language models, malicious actors can create new ways to attach a network or penetrate network security. With the constantly evolving threat landscape, a service provider of customer networks can get flooded with alerts indicating potential security incidents across the customer networks. For instance, the service provider may utilize a security datacenter that receives the alerts from all networks. Some of the security incidents may be malicious, while others may be benign. However, to determine whether alerts correspond to an attack or not, each security incident is investigated.

Current techniques for incident investigations are performed manually or semi-manually, where an incident may be pre-analyzed and then provided to a user (e.g., an employee of the service provider) in order to classify the incident. Each user is specially trained to identify security incidents within a particular tier. However, there is a shortage of qualified individuals that can efficiently and accurately classify security events. Moreover, some security incidents may require an immediate response. However, due to the sheer volume of alerts a security center may receive, identifying and remediating the security incident may not occur in a timely manner. Further, training personnel to categorize security incidents requires each employee to have specialized knowledge and training which is time intensive and costly. Further, even when a person is trained, quality and consistency of the investigation can vary depending on who is involved, resulting in less accurate and inconsistent results.

Moreover, with rapidly evolving technology and the sheer volume of security incidents that get reported in a network continuing to grow, manual review and investigation of each incident may be inefficient and lack scalability and delay of investigation can result in security vulnerabilities to the network.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which an incident investigation system may perform automated investigation of security incidents, according to the techniques described herein.

FIG. 2 illustrates an example environment showing example inputs and outputs of the incident investigation system 108, according to the techniques described herein.

FIG. 3A illustrates an example architecture of agents utilized by the techniques described herein.

FIG. 3B illustrates an example of inputs and outputs of the agents of FIG. 3A, according to the techniques described herein.

FIGS. 4A and 4B collectively illustrate an example process for investigating security incidents using a multi-agent architecture, according to the techniques described herein.

FIG. 5 illustrates a flow diagram of an example method that illustrates aspect of the functions performed at least partly by the devices described in FIGS. 1-4, such as the incident investigation system 108 and/or the network device(s) 106.

FIG. 6 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to network security and more specifically to performing security incident investigations using a multi-agent framework.

A method described herein may be implemented by a multi-agent framework for investigating security incidents across networks of a service provider. The method may include receiving alerts associated with a plurality of security incidents across the networks. The method may also include generating a natural language summary of a security incident of the plurality of security incidents. The method may include determining one or more resources available to a network of the networks associated with the security incident. The method also includes generating, based on data associated with the security incident and the one or more resources, a playbook comprising one or more tasks to investigate the security incident. The method may include generating, based on executing the one or more tasks, outputs associated with the security incident. The method may also include determining, based on the outputs, a status of the security incident. The method further includes generating, based on the status, a recommendation associated with the security incident. The method may also include causing the recommendation and the natural language summary to be displayed via a user interface.

Additionally, the techniques of at least the first method and the second method and any other techniques described herein, may be performed by a system and/or device having non-transitory computer-readable media storing computer-executable instructions that, when executed by one or more processors, performs the method(s) described above.

### Example Embodiments

This disclosure describes techniques for performing security incident investigations using a multi-agent framework.

A service provider may provide services to a plurality of customer networks. The service provider may further utilize a security operations center to help manage security of the customer networks. The security operations center may comprise one or more data centers that receive the alerts from across customer networks. Some of the security incidents may be malicious, while others may be benign. However, to determine whether alerts correspond to an attack or not, each security incident is investigated.

Current techniques for incident investigations are performed manually or semi-manually, where an incident may be pre-analyzed and then provided to a user (e.g., an employee of the service provider) in order to classify the incident. Current techniques may utilize a tiered investigation process, where each user (e.g., employee) of the security operations center is trained to perform the investigative tasks associated with each tier. A first tier may comprise monitoring security alerts and performing initial triage. A second tier may include performing an in-depth analysis of a security incident and identifying remedial actions. A third tier may include performing advance analysis of the security incident, threat hunting, and/or forensics. A fourth tier may include performing or applying a security architecture and/or policy development. A fifth tier may include actions related to an enhanced security posture. Each user is specially trained to identify security incidents within a particular tier. However, there is a shortage of qualified individuals that can efficiently and accurately classify security events. Moreover, some security incidents may require an immediate response. However, due to the sheer volume of alerts a security center may receive, identifying and remediating the security incident may not occur in a timely manner. Further, training personnel to categorize security incidents requires each employee to have specialized knowledge and training which is time intensive and costly. Further, even when a person is trained, quality and consistency of the investigation can vary depending on who is involved, resulting in less accurate and inconsistent results.

Moreover, with rapidly evolving technology and the sheer volume of security incidents that get reported in a network continuing to grow, manual review and investigation of each incident may be inefficient and lack scalability and delay of investigation can result in security vulnerabilities to the network.

The techniques described herein are directed to systems and methods for performing security incident investigation using a multi-agent architecture. For instance, the system may include receiving alerts associated with a plurality of security incidents across the networks. The system may include generating a natural language summary of a security incident of the plurality of security incidents. The system may include determining one or more resources available to a network of the networks associated with the security incident. The system may include generating, based on data associated with the security incident and the one or more resources, a playbook comprising one or more tasks to investigate the security incident. The system may include generating, based on executing the one or more tasks, outputs associated with the security incident. The system may include determining, based on the outputs, a status of the security incident. The system may include generating, based on the status, a recommendation associated with the security incident and causing the recommendation and the natural language summary to be displayed via a user interface.

In some examples, the system may include an agent component. The agent component may comprise a plurality of agents (e.g., language models or code) configured to perform investigation(s) of security incidents. The agent component may correspond to a multi-agent architecture. The agent component may comprise a plurality of agents configured to collaboratively investigate security incidents. For instance, the agent component may include one or more of an orchestration agent, a summarization agent, a planner agent, tooling agent(s), and/or triage and recommendation agent(s). Each agent may comprise a generative AI model trained and/or updated independently using domain-specific data. Accordingly, the system may utilize a multi-agent architecture to divide the complex task of incident investigation into smaller pieces, enabling each agent to provide specialized and faster results that are more accurate and less resource intensive than existing techniques. In some examples, the agents may be distributed within the network, operating on different device(s), and/or operating at different location(s). The agents may execute independently. For instance, one or more of the agents may execute at different time(s) and/or run in parallel. Accordingly, by enabling the agent(s) to execute independently and/or in parallel, the techniques may provide an efficient way to perform security incident investigations.

In some examples, the orchestration agent may comprise deterministic code (e.g., is not a language model) or may comprise a language model. In some examples, the orchestration agent may be configured to facilitate communication of inputs and outputs between agents. In some examples, the summarization agent may comprise a language model configured to receive the alerts of the security incident in a machine-readable format and generate a summary of the security incident in a natural language format. The summary of the security incident may be included as part of recommendation(s) and/or provided as one of the input(s) to the recommendation agent and/or triage and recommendation agent(s).

In some examples, the planner agent may comprise a language model trained to generate a dynamic playbook of tasks to investigate a security incident. The planner agent may receive the alert data and resource data as inputs from the orchestration agent. Based on the inputs, the planner agent may determine a set of tasks to investigate the security incident, where each task identifies a particular resource and/or a particular tooling agent to execute the task. The planner agent may be configured to provide the dynamic playbook as output to the orchestration agent. The orchestration agent may then identify the tooling agent to send each respective task too. For instance, each tooling agent may be configured to specialize in one or more tasks associated with a particular resource.

For instance, a tooling agent may be configured to specialize in API calls to Splunk, whereas a second tooling agent may be configured to specialize in querying a database of the system. In some examples, each tooling agent may comprise an execution agent and an interpretation agent. The execution agent may comprise code or a language model. The execution agent may be configured to perform the task (e.g., execute an API call for Splunk logs). Where the execution agent is unsuccessful (e.g., API call fails), the execution agent may attempt to execute the task for a threshold number of times. If none of the execution attempts are successful, the execution agent may return an indication that the task failed, which the tooling agent then provides as an output to the orchestration agent. Where the execution agent successfully performs the task, the output of the task (e.g., Splunk log data) and an indication of success are provided to the interpretation agent as inputs. The interpretation agent may comprise a language model configured to receive machine generated data as input and return an answer in natural language format. As an example, where the task is to pull a log of how many times a particular IP address is seen, the execution agent may query Splunk and return a log that is a JSON object. The interpretation agent may receive the JSON object as an input and determines the number of times the IP address is seen, providing the answer as an output in natural language format. The orchestration agent may receive the outputs and indications of success or failure from each of the tooling agent(s) and may provide the outputs and indications as an aggregated input to the triage and recommendation agent.

In some examples, the triage and recommendation agent may comprise one or more agents. For instance, the triage and recommendation agent may comprise a triage agent and/or a recommendation agent. The triage agent may comprise a language model configured to receive the aggregated input and determine a status (e.g., whether the security incident is benign, malicious, etc.) of the security incident. For instance, the triage agent may determine that the security incident is benign based on classifications of similar incidents of other user(s). In some examples, the triage agent may determine a security incident is malicious where a number of users or customer networks have reported similar incidents as being malicious is above a threshold value. In other examples, the triage agent may determine that there is not enough data to classify the security incident. The recommendation agent may comprise a separate language model configured to determine action(s) to take with respect to the security incident and generate a recommendation. For instance, the recommendation agent may utilize historical data (e.g., historical actions taken by user(s) for similar types of incidents, historical user telemetry data, etc.). Where the status of a security incident is benign, the recommendation may assign “no action” as the recommendation. In some examples, the triage agent may be configured to provide the status to the recommendation agent only where the triage agent determines the status is malicious or that additional information is needed. In this example, where the status is determined to be benign, the system may prevent a recommendation from being displayed to a user, such that the user(s) may only see recommendations related to malicious security incidents and/or security incidents that require further investigation or action (e.g., where the recommendation is to “escalate”). Accordingly, the triage and recommendation agent may filter out security incidents that are benign, thereby efficiently processing, classifying, and removing low fidelity alert(s).

In some examples, the recommendation agent may determine that an action needs to occur in real-time to prevent the network from being compromised. In this example, the recommendation agent may cause the action to occur (e.g., block a connection, block a pop-up, etc.) and indicate the status of the recommended action as “action executed”.

In some examples, the recommendation generated by the recommendation agent may include outputs from the tooling agents, a probability that the security incident is malicious, recommended actions, supporting data, a summary of the security incident, etc. The system may provide the recommendation(s) to the user(s) as an output for display via a user interface. In some examples, the recommendation(s) may include one or more selectable elements to enable the user to provide feedback and/or select action(s) to take. For instance, the selectable elements may include the ability to add additional action(s), request an additional investigation be performed, remove one or more action(s), etc.

In some examples, one or more of the agents may comprise generative artificial intelligence. Generative AI is a type of artificial intelligence where models are used to create (or “generate”) new content based on inputs, often in the form of prompts from users. One type of generative AI model is particularly effective at generating text, specifically, the language model (e.g., the large language model (LLM)). Language models are trained on large sets or corpuses of text data to perceive and infer context from inputs (e.g., queries), understand a broader range of queries, and generate human-like textual responses to the queries. However, while language model(s) may be helpful in solving simple tasks, the large or more complex a query is, the less accurate the response may be. Further, the prompts provided to the language model generally be in a natural-language format. However, the alerts and/or other data may be in a machine-readable format (e.g., such as an API call, JSON format, etc.) This may be problematic as many retrieval methods that are used to find relevant information for a prompt (e.g., cosine similarity, Euclidean distance, etc.) are less accurate when comparing data or information in different formats. According to the techniques described herein, one or more agents may comprise language models configured to convert data from the computer-readable format into the natural-language format.

While some of the techniques are described herein as being performed by a security incident system implemented by a network device, some or all of the techniques may be performed by other devices and/or implemented as part of a cloud-based service. Further, while the techniques are described with respect to language models, such as LLMs and small language models (SLMs), any type of models may be used. That is, the models may not necessarily comply with the definitions of LLMs and SLMs, and other types of AI language models capable of performing the tasks described herein may be utilized herein.

Accordingly, the techniques described herein may utilize a multi-agent architecture to divide and conquer complex tasks associated with investigating and classifying security incidents. By assigning smaller tasks to individual agents, the system may improve the accuracy and quality of the output from the agents (e.g., LLMs). Further, by training and updating each agent independently and using independent data sets, the system may prevent inherent bias in the outputs. Further, by utilizing a combination of agents comprising LLMs and executable code, the system may reduce the resource space needed to maintain the agents. Moreover, the system may automate the incident investigation process, reducing costs and time spent investigating and filtering out low fidelity alert signals. Thus, the system may provide a cost effective and scalable way to investigate security incidents across customer network(s) of a service provider. For instance, the system may provide more efficient processing of alert(s) by distributing tasks to different agents; a faster and more comprehensive investigation of security incidents, improved quality and consistency of investigation, as human bias or lack of training is no longer a problem. Further, the architecture is highly scalable, such that the system may be applied across customer networks.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

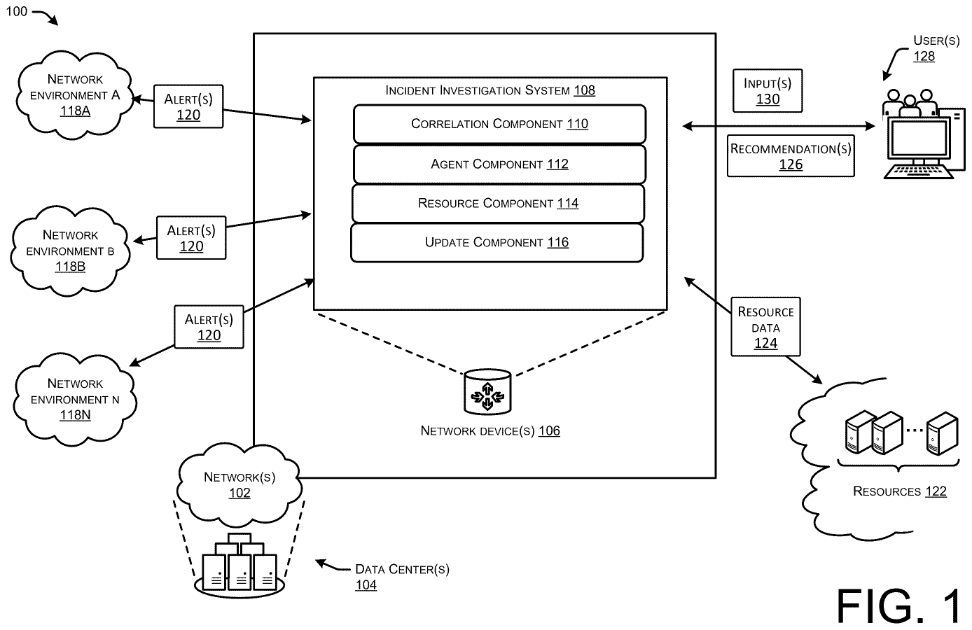

FIG. 1 illustrates a system-architecture diagram of an environment 100 in which an incident investigation system 108 may perform automated investigation of security incidents, according to the techniques described herein.

The environment 100 may include a network(s) 102 that, in some examples, may comprise network device(s) 106 housed or located in one or more data centers 104. The network(s) 102 may include one or more networks implemented by any viable communication technology, such as wired and/or wireless modalities and/or technologies. The network(s) 102 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 102 may include devices, virtual resources, or other nodes that relay packets from one network segment to another by nodes in the computer network. The network(s) 102 may include multiple devices that utilize the network layer (and/or session layer, transport layer, etc.) in the OSI model for packet forwarding, and/or other layers. The network(s) 102 may include various network device(s) 106, such as routers, switches, gateways, firewalls, smart NICs, NICs, ASICs, FPGAs, servers, and/or any other type of device. Further, the network(s) 102 may include virtual resources, such as VMs, containers, and/or other virtual resources. However, the network(s) 102 may be of a different type of architecture, such as a WAN, IoT network, cellular network, or any other type of network.

The one or more data centers 104 may be physical facilities or buildings located across geographic areas that designated to store networked devices that are part of the network(s) 102. The data centers 104 may include various networking devices, as well as redundant or backup components and infrastructure for power supply, data communications connections, environmental controls, and various security devices. In some examples, the data centers 104 may include one or more virtual data centers which are a pool or collection of cloud infrastructure resources specifically designed for enterprise needs, and/or for cloud-based service provider needs. Generally, the data centers 104 (physical and/or virtual) may provide basic resources such as processor (CPU), memory (RAM), storage (disk), and networking (bandwidth). However, in some examples the devices may not be located in explicitly defined data centers 104, but may be located in other locations or buildings. In some examples, the data center(s) 104 may represent a security operations center of a service provider (e.g., such as Cisco).

The network device(s) 106 may be configured to communicate with one or more network environments (e.g., network environment A 118A, network environment B 118B, network environment N 118N). Each network environment may represent a customer network (e.g., enterprise network, private network, public network, etc.) provided by the service provider. As illustrated, each network environment may send alert(s) 120 to an incident investigation system 108. The incident investigation system 108 may be implemented by one or more of the network device(s) 106 and/or provided as part of a cloud service. For instance, the incident investigation system 108 may be implemented as part of Cisco's extended detection and response (XDR) service. The incident investigation system 108 may be configured to perform automated investigation of security incidents and generate recommendations for each security incident that is received at the data center 104.

The incident investigation system 108 may comprise a correlation component 110. In some examples, the correlation component may be configured to receive the alert(s) 120 from each network environment. The alert(s) 120 may comprise a plurality of signals. The correlation component 110 may be configured to determine correlations between one or more of the signals and a particular security incident. For instance, the correlation component may determine that a first subset of the alerts are associated with a first security incident from Network environment A 118A. The correlation component 110 may then provide the first security incident and/or the subset of alerts as an input to the agent component 112.

The incident investigation system 108 may comprise an agent component 112. The agent component 112 may comprise a plurality of agents configured to collaboratively investigate security incidents. For instance, the agent component 112 may include one or more of an orchestration agent, a summarization agent, a planner agent, one or more tooling agent(s), and/or triage and recommendation agent(s). Each agent may comprise a generative AI model trained and/or updated independently using domain-specific data. Accordingly, the system may utilize a multi-agent architecture to divide the complex task of incident investigation into smaller pieces, enabling each agent to provide specialized and faster results that are more accurate and less resource intensive than existing techniques. In some examples, the agent component 112 is configured to perform security incident investigations according to tiers, where a security incident initially is assigned to “tier 1” and, as the security incident is investigated, may be assigned to subsequent tiers. For instance, under existing techniques, a security incident may be manually investigated according to tiers, where user(s) 128 within each tier are responsible for performing specific functions. For instance, “tier 1” users are responsible for monitoring security alert(s) and performing initial triage of security incidents, escalating malicious security incidents, and performing remediation of basic and/or pre-defined security incidents. “Tier 2” users may perform in depth analysis of security incidents, remediation planning, reporting, process improvements. “Tier 3” users may include perform advanced analysis of the security incident, threat hunting, and forensics. “Tier 4” users may perform security architecture and policy development. “Tier 5” users may determine enhanced security posture. As noted above, users are trained and specialized at performing functions associated with their tier of investigation. However, performing the security incident investigation manually is time intensive, costly to train the users, and requires users to have specialized knowledge. Moreover, the investigations within each tier may not be consistent, as each user may have different interpretations of security incidents. Further, the volume of alerts received by the data center(s) 104 (e.g., such as a security operations center) is overwhelming and processing the security incidents fast enough to identify malicious events is simply not feasible.

Accordingly, the incident investigation system 108 may be configured to automate the functions and/or actions associated with tiers 1-3 (and/or any of the tiers) of a security incident investigation. Accordingly, the agent component 112 may be configured to automatically filter out non-essential threats, escalate security incidents, in-depth analysis, remediation, advanced analysis, forensics, proactive threat hunting, etc.

In some examples, the orchestration agent may comprise deterministic code (e.g., is not a language model) or may comprise a language model. In some examples, the orchestration agent may be configured to facilitate communication of inputs and outputs between agents. In some examples, the summarization agent may comprise a language model configured to receive the alerts of the security incident in a machine-readable format and generate a summary of the security incident in a natural language format. The summary may be included as part of recommendation(s) 126.

In some examples, the planner agent may comprise a language model trained to generate a dynamic playbook of tasks to investigate a security incident. The planner agent may receive the alert data (e.g., alert(s) 120) and/or resource data 124 as inputs from the orchestration agent. Based on the inputs, the planner agent may determine a set of tasks to investigate the security incident, where each task identifies a particular resource and/or a particular tooling agent to execute the task. The planner agent may be configured to provide the dynamic playbook as output to the orchestration agent. The orchestration agent may then identify the tooling agent to send each respective task too. For instance, each tooling agent may be configured to specialize in one or more tasks associated with a particular resource. As an example, a first tooling agent may be trained and/or configured to perform tasks associated with a service provider database. Accordingly, where a task may relate to accessing information from the service provider database, the tooling agent may be selected to perform the task.

For instance, a tooling agent may be configured to specialize in API calls to Splunk, whereas a second tooling agent may be configured to specialize in querying a database of the system. In some examples, each tooling agent may comprise an execution agent and an interpretation agent. The execution agent may comprise code or a language model. The execution agent may be configured to perform the task (e.g., execute an API call for Splunk logs). Where the execution agent is unsuccessful (e.g., API call fails), the execution agent may attempt to execute the task for a threshold number of times. If none of the execution attempts are successful, the execution agent may return an indication that the task failed, which the tooling agent then provides as an output to the orchestration agent. Where the execution agent successfully performs the task, the output of the task (e.g., Splunk log data) and an indication of success are provided to the interpretation agent as inputs. The interpretation agent may comprise a language model configured to receive machine generated data as input and return an answer in natural language format. As an example, where the task is to pull a log of how many times a particular IP address is seen, the execution agent may query Splunk and return a log that is a JSON object. The interpretation agent may receive the JSON object as an input and determines the number of times the IP address is seen, providing the answer as an output in natural language format. The orchestration agent may receive the outputs and indications of success or failure from each of the tooling agent(s) and may provide the outputs and indications as an aggregated input to the triage and recommendation agent.

In some examples, the triage and recommendation agent may comprise one or more agents. For instance, the triage and recommendation agent may comprise a triage agent and/or a recommendation agent. The triage agent may comprise a language model configured to receive the aggregated outputs of the tooling agent(s) as input and determine a status (e.g., whether the security incident is benign, malicious, etc.) of the security incident. For instance, the triage agent may determine that the security incident is benign based on classifications of similar incidents of other user(s) 128. In some examples, the triage agent may determine a security incident is malicious where a number of users or customer networks have reported similar incidents as being malicious is above a threshold value. In other examples, the triage agent may determine that there is not enough data to classify the security incident (e.g., status is “undetermined”). In some examples, the triage agent may be configured to provide the status to the recommendation agent only where the triage agent determines the status is malicious or that additional information is needed. In this example, where the status is determined to be benign, the system may prevent a recommendation from being displayed to a user, such that the user(s) 128 may only see recommendations related to malicious security incidents and/or security incidents that require further investigation. Accordingly, the triage and recommendation agent may filter out security incidents that are benign, thereby efficiently processing, classifying, and removing low fidelity alert(s).

The recommendation agent may comprise a separate language model configured to determine action(s) to take with respect to the security incident and generate a recommendation. For instance, the recommendation agent may utilize historical data (e.g., historical actions taken by user(s) 128 for similar types of incidents, historical user telemetry data, etc.). In some examples, the recommendation generated by the recommendation agent may include outputs from the tooling agents, a probability that the security incident is malicious, recommended actions, supporting data, etc. The incident investigation system 108 may provide the recommendation(s) 126 to the user(s) 128 as an output for display via a user interface.

In some examples, the recommendation may include actions and/or details based on a tier associated with the investigation. A security incident investigation may comprise one or more tiers, where each tier is responsible for specific functions. For instance, “tier 1” of investigating a security incident may correspond to monitoring security alert(s) and performing initial triage of security incidents, escalating malicious security incidents, and performing remediation of basic and/or pre-defined security incidents. “Tier 2” may include in depth analysis of security incidents, remediation planning, reporting, process improvements. “Tier 3” may include advanced analysis of the security incident, threat hunting, and forensics. “Tier 4” may include security architecture and policy development. “Tier 5” may include enhanced security posture. Accordingly, the incident investigation system 108 may be configured to automate the functions and/or actions associated with tiers 1-3. Further, the agent component 112 may be configured to generate recommendation(s) 126 based on a tier associated with a security incident. For instance, a “tier 1” recommendation may include the status of the security incident and a recommended action. In some examples, a “tier 2” security incident investigation may determine whether there is enough evidence to correlate the security incident with historical security incidents. In this example, the recommendation agent may determine that additional information is needed to determine whether the security incident is new, whether the security incident has happened before, how often the security incident has occurred, etc. In some examples, such as where the recommendation agent determines additional information is needed, the recommendation agent may be configured to automatically query resource(s) 122 for the additional information and update the recommendation. In some examples, the system may access the additional information in response to input from a user 128. In some examples, a “tier 3” security incident investigation, the recommendation agent may determine whether the investigation is complete. Where the recommendation agent determines the investigation is not complete, the recommendation agent may be configured to automatically launch and perform an additional investigation. In some examples, the system may launch the additional investigation in response to input from a user 128.

The incident investigation system 108 may comprise a resource component 114. The resource component 114 may be configured to access resources 122 and retrieve resource data 124. Resources 122 may comprise an external data source (e.g., such as data lakes of XDR), services available to the service provider (e.g., such as Crowdstrike, etc.), data source(s) available to a particular customer network that the security incident is associated with (e.g., such as Splunk, etc.), internal resources of the service provider (e.g., such as Cisco's TALOS database, VirusTotal, etc.), and/or input from the user 128. In some examples, resource data 124 may include, but is not limited to, context data or findings associated with the data lakes, API or documents of integrated sources of raw detections, log data, API data, threat intelligence data, etc.

The incident investigation system 108 may comprise an update component 116. The update component 116 may be configured to update the agent(s) based on output(s), feedback from user(s) 128, and/or any other data described herein. As an example, the update component 116 may determine that a user 128 provides input(s) 130 comprising request(s) for additional steps to be performed in association with a particular type of investigation or security incident. In this example, the update component 116 may determine that the agent(s) (e.g., language model(s) of one or more of the summarization agent, planner agent, tooling agent(s), and/or triage and recommendation agent(s)) need to be updated to include the additional steps and may provide the additional steps as feedback and/or update data to the language model(s). In some examples, the input(s) 130 may comprise a selection of one or more tasks or recommended actions displayed to the user 128, such as via the recommendation(s) 126.

Accordingly, the incident investigation system 108 may utilize a multi-agent architecture to divide and conquer complex tasks associated with investigating and classifying security incidents. By assigning smaller tasks to individual agents, the system may improve the accuracy and quality of the output from the agents (e.g., LLMs). Further, by training and updating each agent independently and using independent data sets, the system may prevent inherent bias in the outputs. Further, by utilizing a combination of agents comprising LLMs and executable code, the system may reduce the resource space needed to maintain the agents. Moreover, the system may automate the incident investigation process, reducing costs and time spent investigating and filtering out low fidelity alert signals. Thus, the system may provide a cost effective and scalable way to investigate security incidents across customer network(s) of a service provider. For instance, the system may provide more efficient processing of alert(s) by distributing tasks to different agents; a faster and more comprehensive investigation of security incidents, improved quality and consistency of investigation, as human bias or lack of training is no longer a problem. Further, the architecture is highly scalable, such that the system may be applied across customer networks.

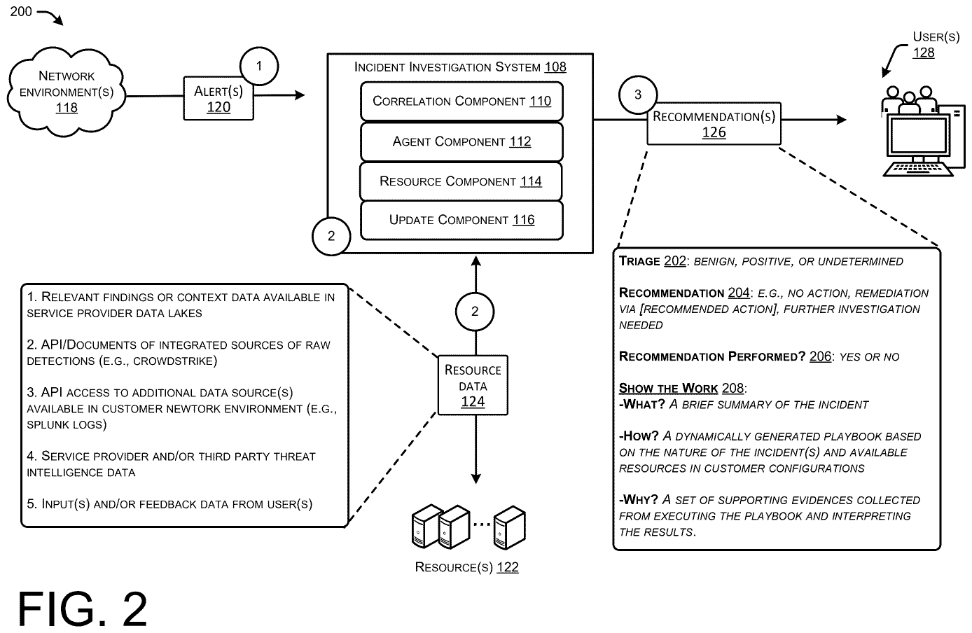

FIG. 2 illustrates an example environment 200 showing example inputs and outputs of the incident investigation system 108, according to the techniques described herein. As illustrated, the environment 200 includes network environment(s) 118, alert(s), user(s) 128, resource(s) 122, incident investigation system 108, recommendation(s) 126, correlation component 110, agent component 112, resource component 114, and/or update component 116.

At “1”, the incident investigation system 108 may receive alert(s) 120 from one or more of the network environment(s) 118. The alert(s) 120 may comprise a plurality of signals associated with one or more security incidents. For instance, a first set of signals may be associated with a security incident at a first network environment (e.g., such as a customer network).

At “2”, the correlation component 110 may determine correlations between the first set of signals and the security incident and provide the first set of signals to the agent component as input. The resource component 114 may access resource(s) 122 to obtain resource data 124. As illustrated in environment 200, resource data may comprise findings or context data available in data lakes of a service provider. For instance, the resource data may include XDR findings and/or XDR context data. The resource data 124 may further include API and/or documents of integrated sources of raw detections, such as data from services such as Crowdstrike, etc. Additionally or alternatively, the resource data 124 may comprise indications and/or access data associated with API access to additional data source(s) available within the customer network that is associated with the security incident. For instance, the resource data 124 may include indications that API access is available within the customer environment to Splunk logs. The resource data 124 may further comprise service provider and/or third-party threat intelligence data and/or inputs or feedback from the user(s) 128. For instance, the threat intelligence data may comprise data from Cisco's TALOS, open-source threat intelligence feeds, etc. The feedback data and/or input(s) from the user(s) 128 may include selections of action(s), feedback from previous investigation(s) of similar security incidents, etc. In some examples, the resource data 124 may comprise policies associated with a network environment 118 of the customer, such as security policies.

At “3”, the incident investigation system 108 may generate and output recommendation(s) 126 for the security incident. As illustrated, the recommendation(s) 126 may comprise a triage 202 field, indicating a status of the security incident. The recommendation(s) 126 may include a recommendation 204 field, comprising a recommended action and/or completed action. In some examples, the recommendation 126 may include a recommendation performed 206 field indicating whether the incident investigation system 108 performed an initial remedial measure (e.g., such as where the security incident requires an immediate remedial measure to prevent network security from being compromised and/or based on a network policy associated with the customer network). The recommendation(s) 126 may include a show the work 208 field that includes one or more of a summary of the security incident (e.g., generated by the summarization agent), the playbook generated by the planner agent, resource(s) accessed by the tooling agent(s), and outputs from executing the tasks. The recommendation(s) 126 may further include selectable elements (not shown) that enable the user(s) 128 to provide feedback, select one or more of the task(s) in the playbook, perform an additional investigation, perform the recommended action, etc.

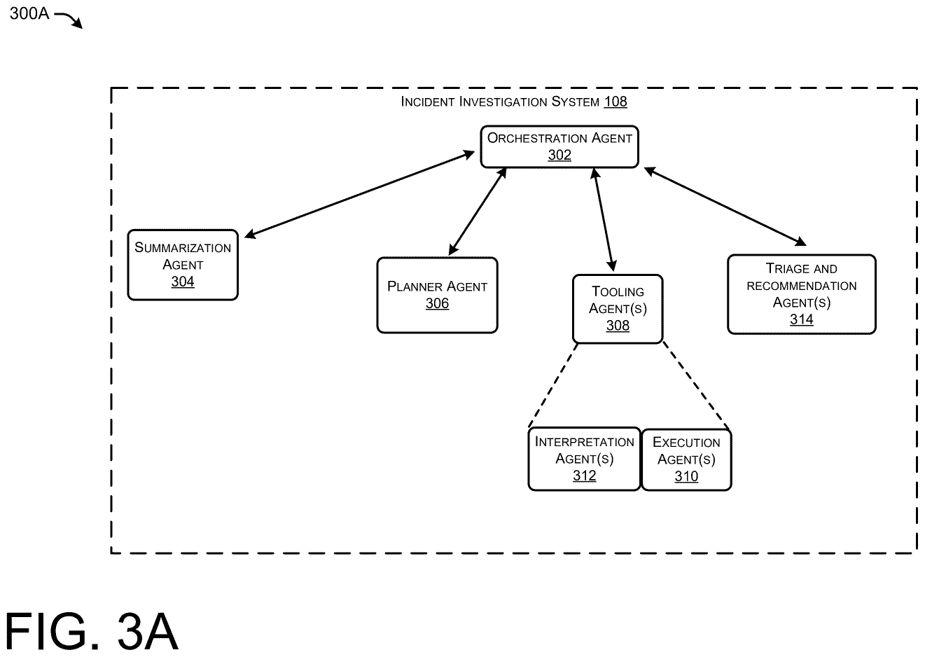

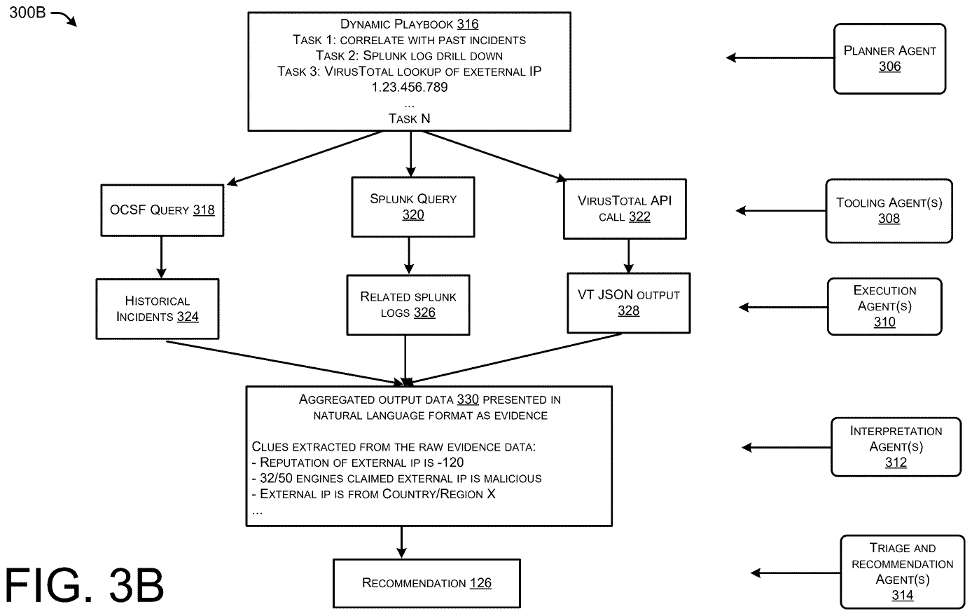

FIG. 3A illustrates an example architecture 300A of agent(s) utilized by the incident investigation system 108, according to the techniques described herein.

For instance, the agent component 112 may include one or more of an orchestration agent, a summarization agent, a planner agent, tooling agent(s), and/or triage and recommendation agent(s). Each agent may comprise a generative AI model trained and/or updated independently using domain-specific data. Accordingly, the system may utilize a multi-agent architecture to divide the complex task of incident investigation into smaller pieces, enabling each agent to provide specialized and faster results that are more accurate and less resource intensive than existing techniques.

In some examples, the orchestration agent 302 may comprise deterministic code (e.g., is not a language model) or may comprise a language model specialized to perform facilitation of communication between agent(s). In some examples, the orchestration agent 302 may be configured to facilitate communication of inputs and outputs between agents. For instance, the orchestration agent 302 may be configured to receive alert data comprising a set of alert(s) 120 associated with a security incident from the correlation component 110. In some examples, the orchestration agent 302 may provide the alert data to the summarization agent 304 as an input.

In some examples, the summarization agent 304 may comprise a language model configured to receive the alert data from the orchestration agent and generate a natural language summary of the security incident. For instance, the summarization agent 304 may receive the alert data, where the alert(s) 120 are in a machine-readable format. The summarization agent 304 may be configured to interpret the machine-readable format and/or convert the alert data into natural language data and, based on the natural language data, generate summary data (e.g., a summary of the security incident) in a natural language format. For instance, the summary data may include a description of what the security incident is (e.g., what type of security incident is occurring, network(s) impacted, number of alert(s) received, client user(s) impacted, whether the security incident is in one or multiple network environment(s) 118, etc.). The summary data may be provided by the orchestration agent 302 to the triage and recommendation agent(s) 314 to be included as part of recommendation(s) 126.

In some examples, the planner agent 306 may comprise a language model trained to generate a dynamic playbook of tasks to investigate a security incident. The planner agent 306 may receive the alert data and resource data 124 as inputs from the orchestration agent 302. Based on the inputs, the planner agent 306 may determine a set of tasks to investigate the security incident, where each task identifies a particular resource and/or a particular tooling agent to execute the task. The planner agent may generate a dynamic playbook that includes the task(s), resources, and/or tooling agent(s). The planner agent 306 may be configured to provide the dynamic playbook as output to the orchestration agent 302. The orchestration agent 302 may then identify the tooling agent to send each respective task too.

In some examples, each tooling agent 308 may be configured to specialize in one or more tasks associated with a particular resource. For instance, a tooling agent may be configured to specialize in API calls to Splunk, whereas a second tooling agent may be configured to specialize in querying a database of the system. In some examples, each tooling agent 308 may comprise an execution agent 310 and an interpretation agent 312. The execution agent may comprise code or a language model. The execution agent may be configured to perform the task (e.g., execute an API call for Splunk logs). Where the execution agent is unsuccessful (e.g., API call fails), the execution agent 310 may attempt to execute the task for a threshold number of times. If none of the execution attempts are successful, the execution agent 310 may return an indication that the task failed, which the tooling agent then provides as an output to the orchestration agent. Where the execution agent 310 successfully performs the task, the output of the task (e.g., Splunk log data) and an indication of success are provided to the interpretation agent 312 as inputs.

The interpretation agent 312 may comprise a language model configured to receive machine generated data as input and return an answer in natural language format. As an example, where the task is to pull a log of how many times a particular IP address is seen, the execution agent may query Splunk and return a log that is a JSON object. The interpretation agent 312 may receive the JSON object as an input and determines the number of times the IP address is seen, providing the answer as an output in natural language format. The orchestration agent 302 may receive the outputs and indications of success or failure from each of the tooling agent(s) 308 and may provide the outputs and indications as an aggregated input to the triage and recommendation agent(s) 314.

In some examples, the triage and recommendation agent(s) 314 may comprise one or more agents. For instance, the triage and recommendation agent(s) 314 may comprise a triage agent and/or a recommendation agent. The triage agent may comprise a language model configured to receive the aggregated input and determine a status (e.g., whether the security incident is benign, malicious, etc.) of the security incident. For instance, the triage agent may determine that the security incident is benign based on classifications of similar incidents of other user(s) 128. In some examples, the triage agent may determine a security incident is malicious where a number of users or customer networks have reported similar incidents as being malicious is above a threshold value. In other examples, the triage agent may determine that there is not enough data to classify the security incident. The recommendation agent may comprise a separate language model configured to determine action(s) to take with respect to the security incident and generate a recommendation. For instance, the recommendation agent may utilize historical data (e.g., historical actions taken by user(s) 128 for similar types of incidents, historical user telemetry data, etc.). Where the status of a security incident is benign, the recommendation may assign “no action” as the recommendation. In some examples, the recommendation generated by the recommendation agent may include outputs from the tooling agents, a probability that the security incident is malicious, recommended actions, supporting data, etc. As noted above, the incident investigation system 108 may provide the recommendation(s) 126 to the user(s) 128 as an output for display via a user interface.

There have been advances in artificial intelligence (AI) that have enabled chatbots and other AI systems to perform complex tasks that normally require human intelligence, such as perceiving, synthesizing, and inferring information. Generally speaking, AI systems and models ingest large amounts of data (or “training data”), analyze this data to identify correlations and patterns, and use these patterns to make predictions about future states. Although AI programs and algorithms have been around for decades, the amount of data and computing power needed to train AI models that are useful for humans has not existed. However, there have been various technological breakthroughs and advances that have accelerated the usefulness of AI, such as advent of cloud computing that provides effectively unlimited compute, advances in specialized hardware (e.g., graphics processing units (GPUs)) that efficiently train and run these AI models, and the discovery of more efficient training algorithms.

Generative AI is a type of artificial intelligence where models are used to create (or “generate”) new content based on inputs, often in the form of prompts from users. One type of generative AI model is particularly effective at generating text, specifically, the large language model (LLM). Language models are trained on large sets or corpuses of text data to perceive and infer context from user queries, understand a broader range of queries, and generate human-like textual responses to the queries. Chatbots that are backed by language models are becoming increasingly popular among users due to their ability to perform complex tasks on behalf of users.

One type of neural network architecture that has gained popularity due to its ability to reduce the amount of time needed to train generative AI models is known as the Transformer model, or simply “Transformers.” Transformers apply a set of mathematical techniques, called attention or self-attention, to capture relationships in sequential data called tokens, such as words in a sentence. Transformers are able to detect subtle causal relationships between data elements in a series, including how even distant data elements influence and depend on each other. Unlike previous models that have to process tokens sequentially (e.g., Recurrent Neural Networks (RNNs)), transformers use an attention mechanism to process tokens simultaneously and calculate the attention weights, or strengths of relationships, between the tokens in successive layers. Because transformers can compute attention weights for all the tokens in parallel, the amount of time needed to train generative AI models using transformers is greatly improved over other training models.

Generative AI can be used to generate text that resembles human-like responses to prompts. Transformers are very effective in training the models used generate text, often referred to as language models. Language models are trained on large sets or corpuses of text data to generate human-like textual responses to prompts. Language models are generally trained in two stages, pre-training and fine-tuning. During the pre-training stage, language models are trained on massive datasets of unlabeled text data (or “unsupervised learning”) where transformers allow the language models to process and learn the patterns and relationships between words. During the fine-tuning stage, the language models can be fine-tuned for specific tasks or prompts, such as summarizing content, answering questions, and text completion. There are generalized language models that have been trained on sets of text data describing all types of content (e.g., data obtained from crawlers that scrape the public Internet). There are also specialized language models that have been trained on specialized sets of data that are specific to a particular type of content, such as networking technology.

The agent(s) described in architecture 300A may comprise off-the-shelf language models that are trained using data sets of the service provider to perform the specialized function. In other examples, the agent(s) comprise language models that are fined tuned and/or specialized for the network. Although illustrated as running on the incident investigation system 108, the agent component 112 may be running and/or stored in remote resources, such as a cloud computing platform, an on-premises computing resource, or other available computing resources.

FIG. 3B illustrates an example environment 300B illustrating example output(s) generated by one or more of the agent(s) described in FIG. 3A. As illustrated, the environment 300B includes planner agent 306, tooling agent(s) 308, execution agent(s) 310, interpretation agent(s) 312, triage and recommendation agent(s) 314, and recommendation 126.

As illustrated in environment 300B and described herein, planner agent 306 may generate a dynamic playbook 316 to investigate a security incident. As illustrated, the dynamic playbook 316 may comprise one or more tasks associated with investigating the security incident to determine whether the security incident is malicious. In some examples, the planner agent 306 may generate the dynamic playbook 316 based on receiving one or more inputs, including receiving examples of playbooks; a chain of reasoning (e.g., provide a prescribed set of steps on how to come up with the playbook), and/or human feedback. In the illustrated example, the dynamic playbook 316 comprises tasks including task 1: correlate (the security incident) with past incidents; task 2: Splunk log drill down; and task 3: VirusTotal lookup of external IP address 1.23.456.789. For instance, the external IP address “1.23.456.789” may be included as part of the alert data and/or associated with the security incident.

As illustrated, each of the tasks are split and provided to different tooling agents as an input. For instance, a first tooling agent may receive “task 1” as an input. In response, the first tooling agent may generate a database query 318 (e.g., a database query to a database of the service provider) in order to access historical data on security incidents. A first execution agent of the first tooling agent may receive the query as input, execute the query and receive historical incidents 324 as an output. The historical incidents 324 may be provided to the interpretation agent(s) 312 as a first input. In some examples, the historical incidents 324 may be in a natural language format. Accordingly, the first interpretation agent may determine whether the external IP address is associated with historical incidents 324 (e.g., such as security incidents on other network environments, a reputation of the external IP address, etc.).

A second tooling agent may receive “task 2”. For instance, the second task may comprise generating a Splunk query 320. The second tooling agent may be configured and/or specialized in performing actions related to Splunk. For instance, the second tooling agent may receive “task 2” as a natural language input and may convert the task into machine-executable language. As an example, in order to perform task 2, the second tooling agent may convert the task into an API call comprising machine-language, that queries Splunk for logs (e.g., such as retrieving a Splunk log of how many times the external IP address is seen). The API call (e.g., Splunk query 320) may be provided to a second execution agent as input. In response to receiving the Splunk query 320, the second execution agent may execute the API call and receive Splunk logs 326 as an output. For instance, the Splunk logs 326 may comprise a JSON object. As described herein, the second interpretation agent of the second tooling agent may receive the JSON object as an input and may interpret the machine-readable code in order to generate a natural language answer. For instance, where the Splunk logs 326 comprise machine-readable language indicating external IP addresses, the second interpretation agent may be configured to look through the JSON object and determine the number of times the particular external IP address is included in the machine-readable language. The second interpretation agent may provide an answer in natural language format. For instance, the interpretation agent may identify that the external IP address is identified in 32/50 engines.

A third tooling agent may receive “task 3”. For instance, the third task may comprise performing a VirusTotal lookup of the external IP address. The third tooling agent may be configured and/or specialized in performing actions related to VirusTotal and/or VirusTotal API calls. For instance, the third tooling agent may receive “task 3” as a natural language input and may convert the task into machine-executable language. As an example, in order to perform task 3, the third tooling agent may generate VirusTotal API call 322, which may comprise machine-language. The VirusTotal API call 322 may be provided to a third execution agent as an input and the third execution agent may execute the VirusTotal API call 322 and receive VT JSON output 328. For instance, the VT JSON output 328 may comprise a JSON object of the VirusTotal lookup data. As described herein, the third interpretation agent may receive the VT JSON output 328 as an input and may interpret the machine-readable code and generate a natural language answer. For instance, where the VT JSON output 328 comprises machine-readable language indicating the lookup data of the external IP addresses, the third interpretation agent may be trained to look through the JSON object and/or convert the JSON object to natural language data and provide the natural language data as output. For instance, the third interpretation agent may provide output indicating the reputation of the external IP address, a country associated with the external IP address, etc.

As illustrated in FIG. 3B, the output(s) of the execution agent(s) 310 and/or interpretation agent(s) 312 may be provided as input (e.g., aggregated output data 330) to the triage and recommendation agent(s) 314. As illustrated the aggregated output data 330 may be presented in natural language format and include one or more indications of evidence to enable the triage and recommendation agent(s) to generate recommendation 126. For instance, the triage and recommendation agent(s) 314 may determine that the status of the security incident is malicious based on the reputation score being below a threshold value, the number of engines claiming the external IP address is malicious being above a threshold value, etc. In some examples, one or more portions of the aggregated output data 330 may be included as part of the recommendation 126.

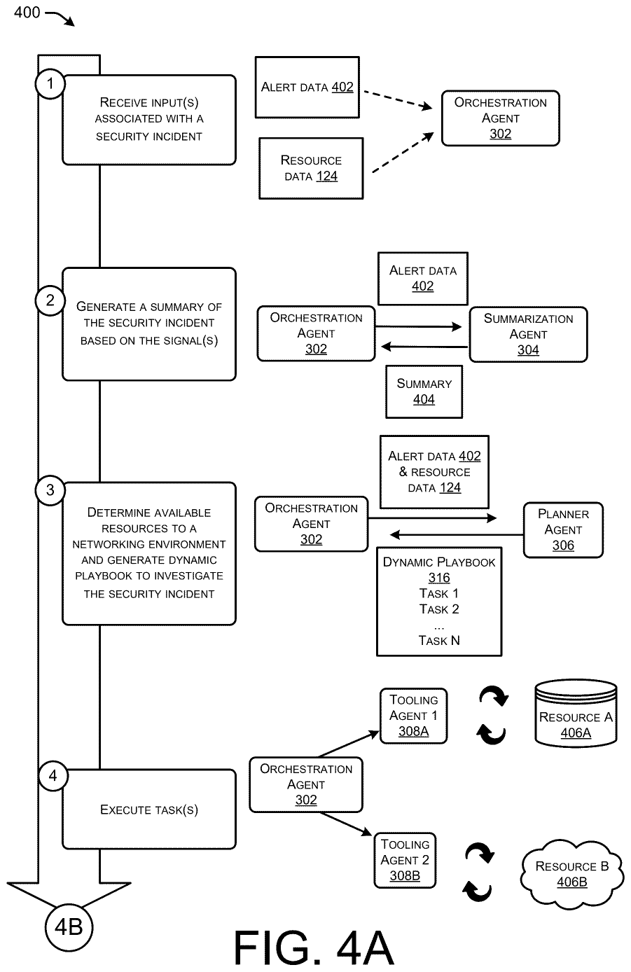

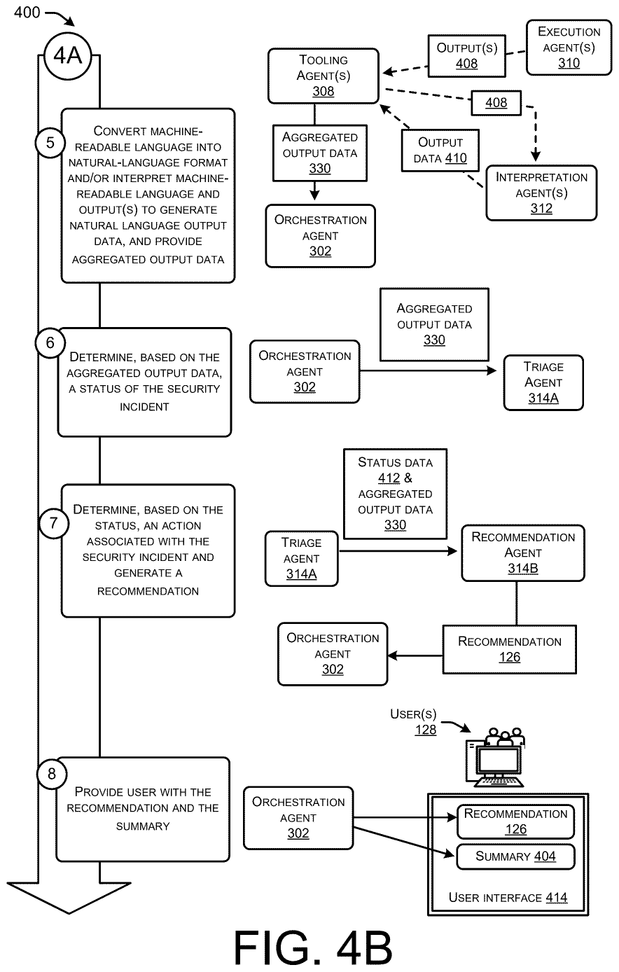

FIGS. 4A and 4B collectively illustrate an example process 400 for investigating security incidents using a multi-agent architecture, according to the techniques described herein.

As illustrated in FIG. 4A, at “1”, the process 400 may include receiving input(s) associated with a security incident. For instance, the orchestration agent 302 may receive input(s) comprise resource data 124, alert data 402, and/or any other suitable data. As described herein, the alert data 402 may comprise one or more signal(s) associated with a security incident. In some examples, the alert data 402 may be in a machine-readable format.

At “2”, the process 400 may include converting signals from machine-readable language into natural language format and generate a summary of the security incident. For instance, the orchestration agent 302 may provide the alert data 402 as input to the summarization agent 304. The summarization agent 304 may be configured to generate a summary 404 of the alert data 402, based on converting the alert data 402 into a natural language format. The summary 404 may comprise a natural language format, as described herein. The summarization agent 304 may provide the summary 404 as an output to the orchestration agent 302.

At “3”, the process 400 may include determining available resources to a networking environment of a customer and generating a dynamic playbook to investigate the security incident. For instance, the orchestration agent 302 may provide the alert data 402, resource data 124, and/or summary 404 to the planner agent 306 as input. In some examples, the planner agent 306 may receive additional or alternative input(s) (e.g., such as examples, alert data in natural language format (e.g., security incident data), etc.). The planner agent 306 may determine tasks to perform to investigate the security incident, as well as resources available in a particular customer network. The dynamic playbook 316 may comprise the list of tasks and resources. The planner agent 306 may output the dynamic playbook 316 to the orchestration agent 302.

At “4”, the process 400 may include executing the task(s) and receiving output(s). For instance, the orchestration agent 302 may provide a first task from the dynamic playbook 316 to tooling agent 1 308A and a second task from the dynamic playbook 316 to tooling agent 2 308B. Each tooling agent may execute the task, as described herein. For instance, tooling agent 1 308A may execute a task associated with resource A 406A, whereas tooling agent 2 308B may execute a task associated with resource B 406B.

As illustrated in FIG. 4B, at “5”, the process 400 may include converting machine-readable language into natural language format and/or interpreting the machine-readable language and outputs to generate natural language output data, and provide aggregated output data. For instance, the tooling agents may execute a task using execution agent(s) 310, which provide output(s) 408. Where the output(s) 408 include data (e.g., execution of the task was successful), the tooling agent(s) 308 may provide the output(s) 408 to interpretation agent(s) 312. As described herein, where the output(s) 408 comprise machine-readable language, the interpretation agent(s) 312 may be configured to convert the output(s) 408 into a natural language format and interpret the natural language data. In some examples, the interpretation agent(s) 312 may receive the output(s) 408 in the machine-readable language and interpret the machine-readable language. For instance, the interpretation agent(s) 312 may be specialized and/or trained to interpret a particular type of machine-readable language and provide output data 410 in a natural language format. In some examples, such as where output(s) 408 comprise a natural language format, the corresponding interpretation agent 312 may receive the natural language format data as input and generate output data 410 in the natural language format. The tooling agent(s) 308 may provide the output data 410 to orchestration agent 302, which may aggregate the output data 410 to generate aggregated output data 330. In some examples, the tooling agent(s) 308 may aggregate the output data 410 and provide the orchestration agent 302 with aggregated output data 330.

At “6”, the process 400 may include determining, based on the aggregated output data, a status of the security incident. For instance, the orchestration agent 302 may provide the aggregated output data 330 to the triage agent 314A as an input. The triage agent 314A may represent a separate agent that is included as part of the triage and recommendation agent(s) 314 described herein. The triage agent 314A may determine the status of the security incident based on the aggregated output data, as described herein.

At “7”, the process 400 may include determining, based on the status, an action associated with the security incident and generating a recommendation. For instance, the triage agent 314A may provide the aggregated output data 330 and the status data 412 (e.g., the determined status) to the recommendation agent 314B as an input. The recommendation agent 314B may determine action(s) associated with the status indicated by the status data 412. For instance, where the status data 412 indicates that the security incident is benign, the recommendation agent 314B may determine “no action” is needed. Where the status data 412 indicates that the security incident is malicious, the recommendation agent 314B may determine remedial action(s), an urgency associated with the remedial action(s), etc. Where the status data 412 indicates that further investigation and/or information is needed, the recommendation agent 314B may determine action(s) associated with the additional investigation (e.g., what information is missing, what type(s) of additional investigation(s) to perform, etc.). The recommendation agent 314B may generate and output recommendation 126 to the orchestration agent 302.

At “8”, the process 400 may include providing a user 128 with the recommendation and the natural language summary. For instance, the orchestration agent 302 may provide the recommendation 126 and/or summary 404 for display to a user 128 via a user interface 414 of a computing device. In some examples, the summary 404 may be included as part of the recommendation 126, as described herein.

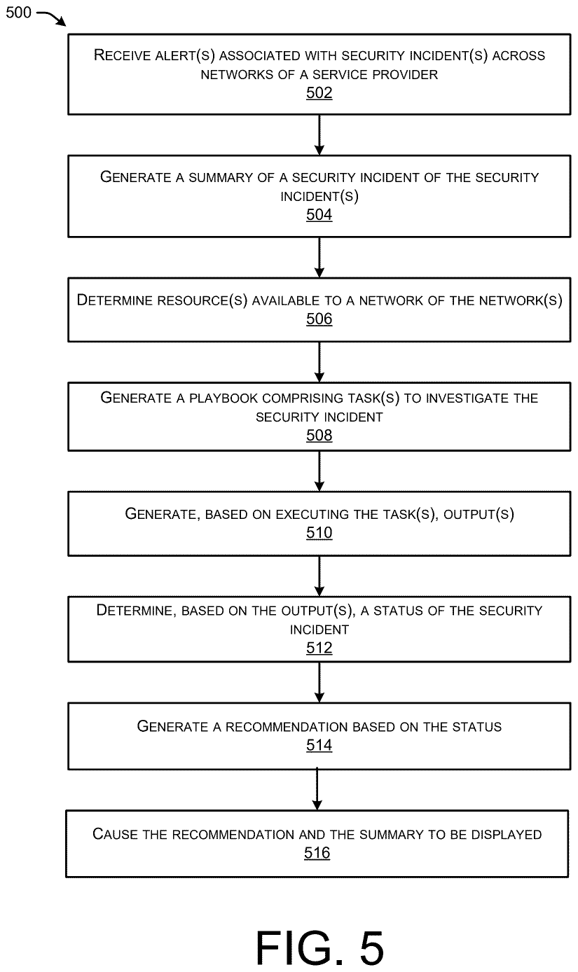

FIG. 5 illustrates a flow diagram of an example method 500 that illustrates aspect of the functions performed at least partly by the devices described in FIGS. 1-4, such as the incident investigation system 108 and/or the network device(s) 106. The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 5 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

At 502, the system may receive alert(s) associated with security incident(s) across networks of a service provider. For instance, the system may receive alert(s) 120 from network environments of customer(s) (e.g., such as network environment A 118A, network environment B 118B, etc.). The alert(s) 120 may comprise a plurality of signal(s) associated with one or more security events. For instance, an alert may be generated in response to detecting a violation of a security policy, a firewall policy, detecting an unknown IP address, etc.

At 504, the system may generate a summary of a security incident of the security incident(s). For instance, the system may generate a natural language summary of the security incident using a first agent comprising a first large language model (LLM) trained using a first dataset to perform a first specialized task. In some examples, the first agent may correspond to the summarization agent 304, as described herein.

At 506, the system may determine resource(s) available to a network of the network(s). In some examples, determining the one or more resources available to the network further comprises one or more of: determining one or more datastores available within an environment of the network; determining one or more integrated data sources available to the service provider; determining one or more third party resources available to the service provider; or determining, one or more inputs received in association with the security incident.

At 508, the system may generate a playbook comprising task(s) to investigate the security incident. In some examples, generating the playbook further comprises: determining, based on the one or more resources, an agent configured to perform a specialized function associated with a particular resource; determining a task corresponding to the particular resource; and assigning the agent execution of the particular task. In some examples, generating the playbook and determining the resources is performed by a second agent comprising a second LLM trained using a second dataset to perform a second specialized task. For instance, the system may generate a dynamic playbook 316 using planner agent 306.

At 510, the system may generate, based on executing task(s), output(s). In some examples, generating the outputs is performed by one or more third agents executing code and/or comprising one or more LLMs trained to perform a specialized task with respect to a particular resource. For instance, the output(s) may comprise output(s) 408 and/or output data 410. In some examples, the task(s) may be performed by one or more tooling agents 308. For instance, as described herein the tooling agent(s) 308 may comprise execution agent(s) 310 configured to execute a function associated with a particular resource. For instance, a tooling agent 308 may specialize in performing functions associated with an external resource (e.g., Splunk), an execution agent of the tooling agent may be configured to execute queries to the external resource, and an interpretation agent of the tooling agent may be configured to interpret the outputs of the queries and provide an answer in natural language format.

At 512, the system may determine, based on the output(s), a status of the security incident. For instance, determining the status may comprise utilizing a triage and recommendation agent 314. For instance, the triage and recommendation agent 314 may comprise one or more LLMs trained using a third dataset to perform a third specialized task.

At 514, the system may generate a recommendation based on the status. For instance, generating the recommendation may be performed by a fifth agent comprising a fourth LLM trained using a third dataset to perform a fourth specialized task. In some examples, the recommendation may be generated by triage and recommendation agent 314, as described herein. In some examples, the triage and recommendation agent may receive and/or access additional inputs, such as historical data, previous recommendations, previous action(s) taken, etc. to generate the recommendation.

In some examples, generating the recommendation further comprises one or more of an indication of whether the security incident is malicious, benign, or more information is needed, a second indication of whether an additional investigation is needed, a recommended action to remediate or mitigate the security incident, resource data accessed, the one or more tasks, and natural language data associated with the outputs.

In some examples, generating, based on the status, the recommendation associated with the security incident comprises: receiving the outputs associated with executing the one or more tasks, the outputs being machine generated code and comprising an indication of whether a task is successful or unsuccessful and, where the task is successful, task data; converting the outputs from the machine generated code into a natural language data; and determining, based on the natural language data, whether the outputs indicate the security incident meets or exceeds a threshold level associated with malicious incidents.

At 516, the system may cause the recommendation and the summary to be displayed. In some examples, prior to causing the recommendation to be displayed, the system may perform the recommended action based on a priority level of the security incident, wherein the recommendation includes a third indication that the recommended action has been performed.

In some examples, the system comprises an agent configured to receive the plurality of security incidents and orchestrate communication between the first agent, the second agent, the one or more third agents, and the fourth agent. For instance, the system may comprise an orchestration agent 302, as described herein.

In some examples, the system may access, based on receiving the alerts, resource data. For instance, the system may access resource data 124 using resource component 114. The system may determine, based on the alerts and the network data, correlations between one or more of the alerts and the security incident. For instance, the system may determine the correlations using correlation component 110 and/or a service of the service provider (e.g., such as Cisco XDR). The system may provide the one or more alerts as input associated with the security incident. For instance, the one or more alerts and/or resource data 124 may be provided to agent component 112 as input.

Accordingly, techniques may utilize a multi-agent architecture to divide and conquer complex tasks associated with investigating and classifying security incidents. By assigning smaller tasks to individual agents, the system may improve the accuracy and quality of the output from the agents (e.g., LLMs). Further, by training and updating each agent independently and using independent data sets, the system may prevent inherent bias in the outputs. Further, by utilizing a combination of agents comprising LLMs and executable code, the system may reduce the resource space needed to maintain the agents. Moreover, the system may automate the incident investigation process, reducing costs and time spent investigating and filtering out low fidelity alert signals. Thus, the system may provide a cost effective and scalable way to investigate security incidents across customer network(s) of a service provider. For instance, the system may provide more efficient processing of alert(s) by distributing tasks to different agents; a faster and more comprehensive investigation of security incidents, improved quality and consistency of investigation, as human bias or lack of training is no longer a problem. Further, the architecture is highly scalable, such that the system may be applied across customer networks.

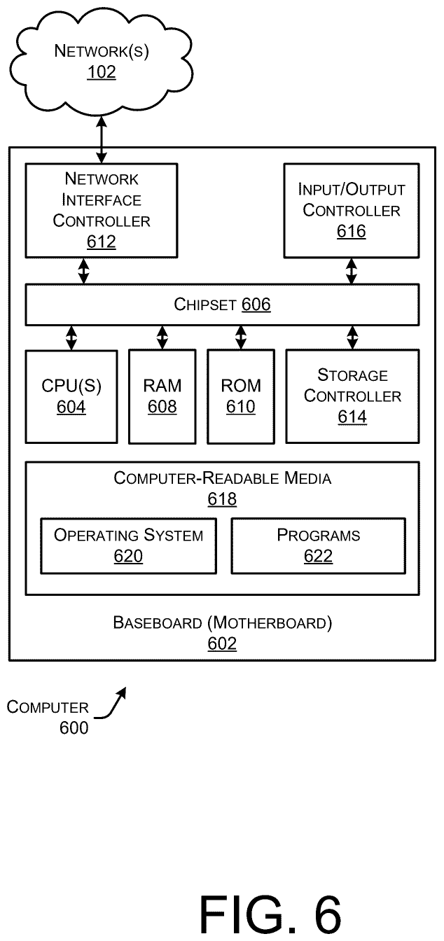

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein.

As described herein, the incident investigation system 108 may be run on the computer 600, or multiple computers. Similarly, the computer 600 may be any type of device, such as network device(s) 106. Thus, the computer 600 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPU(s) 604”) operate in conjunction with a chipset 606. The CPU(s) 604 can be standard programmable processors that perform arithmetic and logical operations necessary for the operation of the computer 600.

The CPU(s) 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPU(s) 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network(s) 102. The chipset 606 can include functionality for providing network connectivity through a NIC 612, such as a gigabit Ethernet adapter. The NIC 612 is capable of connecting the computer 600 to other computing devices over the network(s) 102. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the incident investigation system 108, the network device(s) 106, and or any components included therein, may be supported by one or more devices similar to computer 600. Stated otherwise, some or all of the operations performed by incident investigation system 108 and/or the network device(s) 106, and or any components included therein, may be performed by one or more computer devices (e.g., such as computer 600).

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPU(s) 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in the Figures, can include other components that are not explicitly shown in FIG. 6, or might utilize an architecture completely different than that shown in FIG. 6.

As described herein, the computer 600 may comprise one or more of an incident investigation system 108, the network device(s) 106, and/or any other device. The computer 600 may include one or more hardware processors (e.g., processor(s) 604) configured to execute one or more stored instructions. The processor(s) 604 may comprise one or more cores. Further, the computer 600 may include one or more network interfaces configured to provide communications between the computer 600 and other devices, such as the communications described herein as being performed by the incident investigation system 108 and/or the network device(s) 106. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented by a multi-agent framework for investigating security incidents across networks of a service provider, comprising:
receiving alerts associated with a plurality of security incidents across the networks;
generating a natural language summary of a security incident of the plurality of security incidents;
determining one or more resources available to a network of the networks associated with the security incident;
generating, based on data associated with the security incident and the one or more resources, a playbook comprising one or more tasks to investigate the security incident;
generating, based on executing the one or more tasks, outputs associated with the security incident;
determining, based on the outputs, a status of the security incident;
generating, based on the status, a recommendation associated with the security incident; and
causing the recommendation and the natural language summary to be displayed via a user interface.

2. The method of claim 1, wherein:
generating the natural language summary is performed by a first agent comprising a first large language model (LLM) trained using a first dataset to perform a first specialized task;
generating the playbook and determining the one or more resources is performed by a second agent comprising a second LLM trained using a second dataset to perform a second specialized task;
generating the outputs is performed by one or more third agents executing code; and
generating the recommendation is performed by a fourth agent comprising a third LLM trained using a third dataset to perform a third specialized task.

3. The method of claim 2, further comprising a fifth agent configured to receive the plurality of security incidents and orchestrate communication between the first agent, the second agent, the one or more third agents, and the fourth agent.

4. The method of claim 1, wherein the recommendation further comprises one or more of an indication of whether the security incident is malicious, benign, or more information is needed, a second indication of whether an additional investigation is needed, a recommended action to remediate or mitigate the security incident, resource data accessed, the one or more tasks, and natural language data associated with the outputs.

5. The method of claim 4, wherein prior to causing the recommendation to be displayed, the method further comprises:
performing, the recommended action based on a priority level of the security incident, wherein the recommendation includes a third indication that the recommended action has been performed.

6. The method of claim 1, wherein determining the one or more resources available to the network further comprises one or more of:
determining one or more datastores available within an environment of the network;
determining one or more integrated data sources available to the service provider;
determining one or more third party resources available to the service provider; or
determining, one or more inputs received in association with the security incident.

7. The method of claim 6, wherein:
generating the playbook further comprises:
determining, based on the one or more resources, an agent configured to perform a specialized function associated with a particular resource;
determining a task corresponding to the particular resource; and
assigning the agent the particular task to execute.

8. The method of claim 1, further comprising:
accessing, based on receiving the alerts, resource data;
determining, based on the alerts and the resource data, correlations between one or more alerts and the security incident; and
providing the one or more alerts as input associated with the security incident.

9. The method of claim 1, wherein generating, based on the status, the recommendation associated with the security incident comprises:
receiving the outputs associated with executing the one or more tasks, the outputs being machine generated code and comprising an indication of whether a task is successful or unsuccessful and, where the task is successful, task data;
converting the outputs from the machine generated code into a natural language data; and
determining, based on the natural language data, whether the outputs indicate the security incident meets or exceeds a threshold level associated with malicious incidents.

10. A system comprising:
one or more processors; and
one or more non-transitory computer-readable media that, when executed by the one or more processors, cause the one or more processors to perform operations comprising:
receiving alerts associated with a plurality of security incidents across networks of a service provider;
generating a natural language summary of a security incident of the plurality of security incidents;
determining one or more resources available to a network of the networks associated with the security incident;
generating, based on data associated with the security incident and the one or more resources, a playbook comprising one or more tasks to investigate the security incident;
generating, based on executing the one or more tasks, outputs associated with the security incident;
determining, based on the outputs, a status of the security incident;
generating, based on the status, a recommendation associated with the security incident; and
causing the recommendation and the natural language summary to be displayed via a user interface.

11. The system of claim 10, wherein the outputs comprise natural language data, the outputs being generated in part based on receiving machine-readable data as input and interpreting the machine-readable data to generate the outputs.

12. The system of claim 10, wherein:
generating the natural language summary is performed by a first agent comprising a first large language model (LLM) trained using a first dataset to perform a first specialized task;
generating the playbook and determining the one or more resources is performed by a second agent comprising a second LLM trained using a second dataset to perform a second specialized task;
generating the outputs is performed by one or more third agents executing code; and
generating the recommendation is performed by a fourth agent comprising a third LLM trained using a third dataset to perform a third specialized task.

13. The system of claim 12, further comprising a fifth agent configured to receive the plurality of security incidents and orchestrate communication between the first agent, the second agent, the one or more third agents, and the fourth agent.

14. The system of claim 10, wherein the recommendation further comprises one or more of an indication of whether the security incident is malicious, benign, or more information is needed, a second indication of whether an additional investigation is needed, a recommended action to remediate or mitigate the security incident, resource data accessed, the one or more tasks, and natural language data associated with the outputs.

15. The system of claim 14, wherein prior to causing the recommendation to be displayed, the operations further comprise:
performing, the recommended action based on a priority level of the security incident, wherein the recommendation includes a third indication that the recommended action has been performed.

16. The system of claim 10, determining the one or more resources available to the network further comprises one or more of:
determining one or more datastores available within an environment of the network;
determining one or more integrated data sources available to the service provider;
determining one or more third party resources available to the service provider; or
determining, one or more inputs received in association with the security incident.

17. The system of claim 16, wherein:
generating the playbook further comprises:
determining, based on the one or more resources, an agent configured to perform a specialized function associated with a particular resource;
determining a task corresponding to the particular resource; and
assigning the agent the particular task to execute.

18. The system of claim 10, the operations further comprising:
accessing, based on receiving the alerts, resource data;
determining, based on the alerts and the resource data, correlations between one or more alerts and the security incident; and
providing the one or more alerts as input associated with the security incident.

19. The system of claim 10, wherein generating, based on the status, the recommendation associated with the security incident comprises:
receiving the outputs associated with executing the one or more tasks, the outputs being machine generated code and comprising an indication of whether a task is successful or unsuccessful and, where the task is successful, task data;
converting the outputs from the machine generated code into a natural language data; and
determining, based on the natural language data, whether the outputs indicate the security incident meets or exceeds a threshold level associated with malicious incidents.

20. One or more non-transitory computer-readable media storing instructions executable by one or more processors, wherein the instructions, when executed, cause the one or more processors to perform operations comprising:
receiving alerts associated with a plurality of security incidents;
generating a summary of a security incident of the plurality of security incidents;
determining one or more resources available to a network associated with the security incident;
generating, based on data associated with the security incident and the one or more resources, a playbook comprising one or more tasks to investigate the security incident;
generating, based on executing the one or more tasks, outputs associated with the security incident;
generating, based on the outputs, a recommendation associated with the security incident, the recommendation including the summary; and
causing the recommendation to be displayed via a user interface.
